(19) United States
(12) Patent Application Publication
(10) Pub. No.: US 2025/0010279 A1
(43) Pub. Date: Jan. 9, 2025

(54) SYNTHESIS OF CARBONYLATION CATALYSTS

(71) Applicant: Novomer, Inc., Rochester, NY (US)

(72) Inventors: Alison M. Wilders, Rochester, NY (US); Jonathan D. Tedder, Rochester, NY (US); Ronald Boyce, Rochester, NY (US); Ashley Joseph, Rochester, NY (US)

(21) Appl. No.: 18/710,403

(22) PCT Filed: Nov. 16, 2022
(86) PCT No.: PCT/US2022/050085

§ 371 Date: May 15, 2024

Related U.S. Application Data
(60) Provisional application No. 63/280,385, filed on Nov. 17, 2021.

(51) Int. Cl. B01J 31/22; B01J 31/16; B01J 37/00; B01J 37/04

(52) U.S. Cl. CPC B01J 31/2295; B01J 31/1616; B01J 37/009; B01J 37/04; B01J 2531/31

(57) ABSTRACT

A method including contacting a ligand complex, a metalation compound, and a metal carbonyl in a mixture to form a catalyst. The ligand complex includes one or more of phosphine, imine, and/or hydroxyl groups bound to one or more cyclic structures. The method includes separating the catalyst from the mixture. Contacting the ligand complex with a metalation compound and the metal carbonyl in the mixture to form a catalyst is conducted without isolating any intermediates, performed within a single vessel, and/or performed in a moisture, oxygen, and/or air free environment.

### CROSS-REFERENCE TO RELATED APPLICATIONS

This application claims priority to and benefit of U.S. Provisional Application No. 63/280,385, filed on Nov. 17, 2021, which is incorporated herein by reference in its entirety.

### FIELD

The present disclosure relates to a method for making carbonylation catalysts from ligand complexes, metalation compounds, and metal carbonyls.

### BACKGROUND

Carbonylation is a process that can be used to react carbon monoxide and an epoxide to make a lactone. In some cases, additional steps are taken to react the lactones to make polymers. These lactones or polymers thereof are often used as plastics and disinfectants. When making these lactones, a carbonylation catalyst is used to optimize the efficiency of the reaction to produce lactones at competitive prices. Carbonylation catalysts are expensive, and thus, new techniques to synthesize the carbonylation catalysts from simple components are needed. Some catalysts have been made using a variety of ligands. For example, see U.S. Pat. No. 6,852,865. However, the process to synthesize the carbonylation catalyst from these ligands can utilize many synthetic and purification steps.

Accordingly, what is needed are techniques to form carbonylation catalysts that have little waste and can be performed in a short period of time.

### SUMMARY

Disclosed herein are compounds useful as carbonylation catalysts. The methods used to prepare such compounds start with a ligand complex, a metalation compound, and a metal carbonyl to yield a carbonylation catalyst without isolating any intermediates before yielding the carbonylation catalyst. Contacting the metalation compound and the ligand complex in a hydrocarbon solvent forms a metalated ligand complex. After forming the metalated ligand complex, the metal carbonyl and polar solvent may be added to the same reaction mixture to yield a carbonylation catalyst, without isolating any intermediate compounds, such as the metalated ligand complex. After forming the carbonylation catalyst, the reaction mixture of ingredients can be subjected to a known method for separating solids from liquids, for example gravity filtration, to yield the carbonylation catalyst in a form that is sufficient to catalyze a carbonylation reaction (i.e., formation of a lactone) or other similar ring opening reaction (i.e., formation of a lactam).

The carbonylation catalysts formed by the techniques described herein may contain impurities. The carbonylation catalysts exhibit high catalytic activity in the presence of such impurities to form lactones and/or lactams. Because no intermediates need to be filtered or isolated, the amount of solvents used can be limited to what is needed to perform the reaction steps, until the carbonylation catalyst is formed as a precipitate and separated from the reaction mixture (i.e., slurry). This process requires relatively little solvent to carry out the synthetic sequence because no intermediates need to be isolated and the final product does not need to be further purified, for example by crystallization. Without the need for additional steps, solvent waste is reduced and the amount of time spent synthesizing and isolating compounds is significantly reduced.

The ligand complex includes one or more of phosphine, imine, and/or hydroxyl groups bound to one or more cyclic structures. The ligand complex may have any structure sufficient to assist with formation of a lactam and/or lactone when the ligand complex is integrated with a metal and, subsequently, into a carbonylation catalyst. The metalation compound includes a metal that coordinates to the ligand complex. The metal carbonyl includes a metal bound to one or more carbonyls that can ionically bind with the metaled ligand complex. One intermediate of the method includes a metalated ligand complex, which is a ligand complex that is coordinated to one or more metals, and the metalated ligand complex is contacted with the metal carbonyl to ionically bind and form the carbonylation catalyst.

The carbonylation catalyst is a combination of an anionic compound and a cationic compound. For example, the carbonylation catalyst may be a metalated ligand compound that is cationic, and the metalated ligand compound is ionically bound with a metal carbonyl that is anionic. Additionally, the carbonylation catalyst may include one or more other polar ligands coordinated to the metal of the metalated ligand compound so that the polar solvent used herein may have a dual purpose (i.e., facilitating the reaction and coordinating to the metal). The carbonylation catalyst includes at least two metal compounds that are ionically bound together. For example, an aluminum coordinated to a ligand complex may be ionically bound to a cobalt carbonyl. The carbonylation catalyst may be any catalyst containing a metal center and having catalytic activity with one or more of an epoxide, a lactone, an aziridine, a lactam or any combination thereof. The metal of the cationic or anionic component of the carbonylation catalyst may be any metal sufficient to catalyze carbonylation or perform a ring opening reaction. As an example, the carbonylation catalyst may have a structure according to the following formulas:

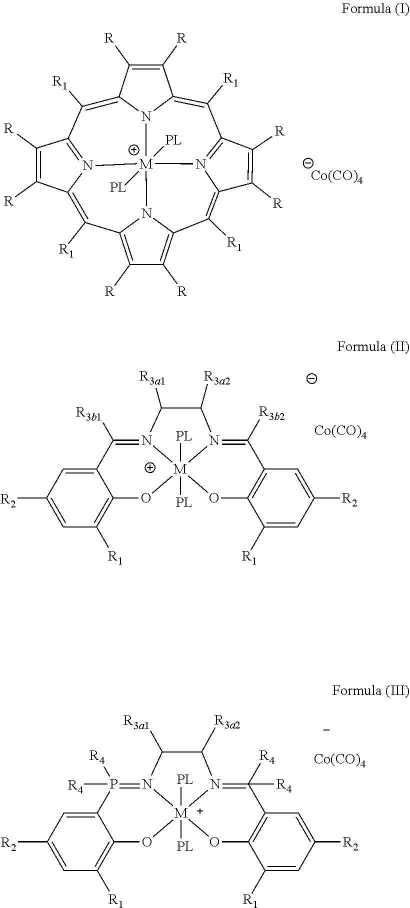

where M may be selected from aluminum, chromium, gallium, indium, zinc, copper, manganese, cobalt, ruthenium, iron, rhenium, nickel, palladium, magnesium, titanium, or any combination thereof.
where each R may independently at each occurrence include hydrogen, halogen, —OR⁴, —NR^{y}₂, —SR, —ON, —NO₂, —SO₂R^{y}, —SOR^{Y}, —SO₂NR^{y}₂; —CNO, —NRSO₂R^{y}, —NCO, —N₃, —SiR₃; or an optionally substituted group selected from the group consisting of C₁₋₂₀aliphatic; C₁₋₂₀ heteroaliphatic having 1-4 heteroatoms independently selected from the group consisting of nitrogen, oxygen, and sulfur; 6 to 10 membered aryl; 5 to 10 membered heteroaryl having 1 to 4 heteroatoms independently selected from nitrogen, oxygen, or sulfur; and 4 to 7 membered heterocyclic having 1 to 2 heteroatoms independently selected from the group consisting of nitrogen, oxygen, and sulfur, where two or more R^{d} groups may be taken together to form one or more optionally substituted rings, and each R^{y} is independently hydrogen, or an optionally substituted group selected the group consisting of: acyl; carbamoyl, arylalkyl; 6 to 10 membered aryl; C₁₋₁₂ aliphatic; C₁₋₁₂ heteroaliphatic having 1 to 2 heteroatoms independently selected from the group consisting of nitrogen, oxygen, and sulfur; 5 to 10 membered heteroaryl having 1 to 4 heteroatoms independently selected from the group consisting of nitrogen, oxygen, and sulfur; 4 to 7 membered heterocyclic having 1 to 2 heteroatoms independently selected from the group consisting of nitrogen, oxygen, and sulfur; an oxygen protecting group; and a nitrogen protecting group; where two R^{y} on the same nitrogen atom may be taken with the nitrogen atom to form an optionally substituted 4 to 7 membered heterocyclic ring having 0 to 2 additional heteroatoms independently selected from the group consisting of nitrogen, oxygen, and sulfur.
where each R₁ may be a group independently selected from one or more of hydrogen, halogen, heteroaliphatic, heterocyclic, heteroaromatic, alkyl, alkoxide, aryl, silyl alkyl, alkyl-aryl, amine, trifluoromethyl, nitro, hydrocarbyl oxy, derivatives thereof, substituted groups thereof, or any combination thereof.
where each R₂ may be a group independently selected from one or more of hydrogen, alkyl, alkoxide, aryl, silyl alkyl, alkyl-aryl, amine, trifluoromethyl, nitro, hydrocarbyl oxy, derivatives thereof, substituted groups thereof, or any combination thereof.
where R₃ₐ₁ and/or R₃ₐ₂ may be independently selected from one or more of hydrogen, methyl, a C₂₋₁₀ alkyl chain, a combination thereof, or in combination form a cyclohexane or a phenyl group that is optionally substituted. The substituted groups may include aromatic groups, aliphatic groups, or both.
where R_{3b1} and/or R_{3b2} may be independently selected from one or more of hydrogen, methyl, a C₂₋₁₀ alkyl chain, or a combination thereof.
where R₃ₐ₁ and R_{3b1} may in combination form one or more of a heterocyclic compound, a heterocyclic ring having one or more substitutions, a cyclic structure, any combination thereof.
R₃ₐ₁ and R_{3b1} may in combination form a six membered ring that is optionally substituted, aromatic, or both. A heterocyclic ring may include pyridine, a pyridine having one or more substitutions, or any combination thereof.
where R₃ₐ₂ and R_{3b2} may in combination form one or more of a pyridine, a pyridine having one or more substitutions, a cyclic structure, any combination thereof. R₃ₐ₂ and R_{3b2} may in combination form a six membered ring that is optionally substituted, aromatic, or both. where independently one of the R₄ groups and R₃ₐ₁ and/or R₃ₐ₂ may in combination each independently form one or more of a cyclic structure. The cyclic structure may include one or more of a heterocyclic compound, an aromatic compound, or any combination thereof. The cyclic structure may include one or more of cyclohexane, a phenyl group, a pyridine, or any combination thereof.

Disclosed are methods including contacting a ligand complex, a metalation compound, and a metal carbonyl in a reaction mixture to form a catalyst. The method includes separating the catalyst from the reaction mixture.

The catalyst may include the metalated ligand complex ionically bound to the metal carbonyl in an amount of about 90 to about 98 weight percent or more; and the ligand complex that is unbound in an amount of about 10 to about 2 weight percent or less, where weight percent is based on the total weight of the catalyst. The polar solvent may be contacted with the reaction mixture in a volumetric ratio between about 2:1 or less and about 0.5:1 or less. The metalation compound may be contacted with the ligand complex in a molar ratio of about 1:1 or more.

Contacting the ligand complex with a metalation compound and the metal carbonyl in the reaction mixture to form a catalyst may be performed without isolating any intermediates. Contacting the ligand complex with a metalation compound and the metal carbonyl in a reaction mixture to form a catalyst may be performed, in one or more vessels or in a single vessel. Contacting the ligand complex, the metalation compound, and the metal carbonyl in the reaction mixture to form a catalyst may be performed in a moisture, an air, and/or an oxygen free environment.

Contacting the ligand complex, the metalation compound, and the metal carbonyl in the reaction mixture to form the catalyst may include mixing the reaction mixture. The amount of time that the reaction mixture is mixed to form the metalated ligand complex and/or the catalyst may be impacted by the concentration of reactants or solvents in the reaction mixture, by application of heat, and the particular choice and ratio of the solvents. While the reaction mixture is being mixed to form the catalyst, the combination of a polar and a hydrocarbon solvent may precipitate the catalyst. The reaction mixture containing the ligand complex, the metalation compound, and the metal carbonyl may be mixed for about 1.5 hours or more or about 12 hours or more to form the catalyst. Contacting the ligand complex, the metalation compound, and the metal carbonyl in the reaction mixture to form the catalyst may include mixing the reaction mixture while applying heat or without applying heat. Contacting the ligand complex, the metalation compound, and the metal carbonyl may be discussed as first and second mixtures without isolating any intermediates between the first and second mixtures. In a first mixture, the ligand complex, a hydrocarbon solvent, and the metalation compound may be mixed to form the metalated ligand complex. In a second mixture, the metalated ligand complex, the hydrocarbon solvent, a polar solvent, and a metal carbonyl may be mixed to form the catalyst,

In the first mixture, the ligand complex and the hydrocarbon solvent may be mixed for any period of time sufficient to at least partially dissolve the ligand complex. Then, the metalation compound may be added to the first mixture and mixed for about 0.5 hours or more to about 7 hours or more to form the metalated ligand complex.

A polar ligand and a metal carbonyl may be added to the first mixture to form a second mixture, and mixing the second mixture forms the catalyst. The second mixture containing the metalated ligand complex, the metal carbonyl, the polar solvent, and the hydrocarbon solvent that forms the catalyst may be mixed for about 1 hour or more or 2 hours or more. Addition of the polar solvent to the first mixture increases solubility of the metalated ligand complex, and after formation of the catalyst, the polar solvent coordinates to the catalyst. The combination of the polar and hydrocarbon solvents in the second mixture precipitates the catalyst from the second mixture after the catalyst is formed.

The method may include contacting the first mixture containing the metalated ligand complex and the hydrocarbon solvent with the polar solvent to form the second mixture; sparging the second mixture with a gas at a pressure sufficient to assist formation of the catalyst; and contacting the second mixture containing the metalated ligand complex, the polar solvent, and the hydrocarbon solvent with the metal carbonyl to form the catalyst. The second mixture may be sparged with the gas at a pressure of about 100 kPa or below.

Separating the catalyst from the reaction mixture may include filtering the catalyst from the final reaction mixture; applying a vacuum to the catalyst to remove any remaining volatile materials, such as hydrocarbon and/or polar solvents from the catalyst; applying heat to the catalyst to remove any remaining volatile materials, such as hydrocarbon and/or polar solvent from the catalyst; and/or applying a nitrogen stream to the catalyst to remove any remaining volatile materials, such as hydrocarbon and/or polar solvent from the catalyst.

The above steps of forming the catalyst by mixing the ligand complex, the metalation compound, and the metal carbonyl in the reaction mixture and separating the catalyst from the reaction mixture produce a catalyst with high purity and catalytic activity when forming lactones and/or lactams. When an even higher purity is desired, the catalyst that is separated from the reaction mixture may be subjected to a recrystallization step to remove any other impurities that are mixed with the catalyst. The method may further include contacting the catalyst that is removed from the reaction mixture with one or more solvents to form a crystallization mixture; precipitating the catalyst from the crystallization mixture; and separating the catalyst from the one or more solvents. The one or more solvents may include one or more polar solvents and one or more hydrocarbon solvents, and contacting the catalyst that is removed from the reaction mixture with the one or more solvents to form the crystallization mixture may include contacting the catalyst that is removed from the previous reaction mixture with the one or more polar solvents and the one or more hydrocarbon solvents to form the crystallization mixture; heating the crystallization mixture to a temperature sufficient to dissolve the catalyst in the one or more polar solvents and the one or more hydrocarbon solvents; and cooling the crystallization mixture so that the catalyst crystallizes and precipitates from the one or more polar solvents and the one or more hydrocarbon solvents. Separating the one or more solvents and/or the one or more other compounds from the catalyst may include separating the one or more polar solvents and/or the one or more hydrocarbon solvents so that the catalyst is substantially free of other compounds. The method may further include rinsing the catalyst with one or more hydrocarbon solvents.

The reaction mixture, crystallization mixture, first mixture, second mixture, or any combination thereof may be a solution and/or a slurry. The ligand complex may include aromatic groups, and the ligand complex may include imine or phosphazine groups and one or more cyclic structures that are conjugated. The ligand complex may include a macrocycle. The ligand complex may include one or more of a porphyrin ligand, a salen ligand, a salph ligand, a salcy ligand, a phophasalen ligand, a phosphasalph ligand, a phosphasalcy ligand, a disubstituted bipyridine ligand, a disubstituted phenanthroline ligand, a dibenzotetramethyltetraaza[14]annulene derivative, a phthalocyanine derivative, a diaminocyclohexane derivative (e.g., a Trost ligand), other derivatives thereof, or any combination thereof. The method may further include dissolving the metalation compound in a hydrocarbon solvent to form a precursor mixture having a molarity of about 1.0 or more, and the precursor mixture may be contacted with the reaction mixture containing the ligand complex and the hydrocarbon solvent. The method may include addition of the metalation compound to the mixture containing the ligand complex and the hydrocarbon solvent without first dissolving the metalation compound in any solvent. The metalation compound may include aluminum or chromium. The metalation compound may include one or more of triethylaluminum, trimethylaluminum, triisobutylaluminum, chromium (II) chloride, diethyl aluminum chloride, or any combination thereof. The metalation compound may include a trialkyl aluminum compound. The metal carbonyl may include cobalt. The metal carbonyl may include one or more of NaCo(CO)₄, HCo(CO)₄, Co₂(CO)₈, any Coₓ(CO)_{y} compound where x and y are independently integers between 1 and 12 or a combination thereof. The gas inserted during the sparging step may include one or more of carbon monoxide, syngas, or a combination thereof. The other gas removed by the sparging step may include an inert gas such as one or more of argon, nitrogen, or both. The hydrocarbon solvent may include a linear or cyclic structure that includes only carbon and hydrogen. The hydrocarbon solvent may be aromatic, aliphatic or have both aromatic and aliphatic portions. The hydrocarbon solvent may include one or more of hexane, heptane, pentane, benzene, toluene, xylene, any other hydrocarbon, or any combination thereof. The polar solvent may include a polar aprotic solvent. The polar solvent may include one or more esters, ketones, aldehydes, ethers, nitriles or any combination thereof. The polar solvent may include one or more of tetrahydrofuran, ethyl acetate, methyl ethyl ketone, acetone, 2-cyclohexanone, 2-methyl tetrahydrofuran, butyl acetate, methyl acetate, cyclopentanone, or any combination thereof.

The present disclosure provides carbonylation catalysts that possess high catalytic activity with epoxides or aziridines to form lactones or lactams. The present disclosure provides methods for synthesizing the carbonylation catalyst that reduces the amount of solvent required to purify the carbonylation catalyst by up to about 80 percent or less because various purification steps are not required to form a carbonylation catalyst with high catalytic activity. By reducing the number of steps utilized to form a carbonylation catalyst with high catalytic activity, a significant amount of time is saved when conducting the reaction because no intermediates need to be isolated, so the capital cost of the overall reaction is significantly reduced. The techniques provide a final carbonylation catalyst with a molar yield of about 90 percent or more. The techniques provide a carbonylation catalyst that has catalytic activity before or without being subjected to a crystallization step.

### BRIEF DESCRIPTION

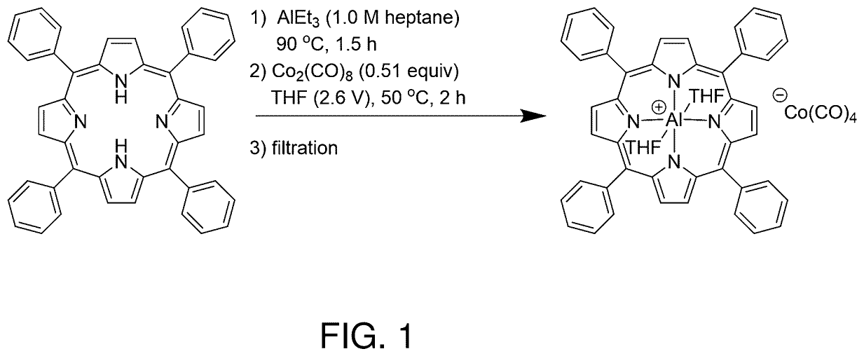

FIG. 1 is a synthetic scheme to form a carbonylation catalyst.

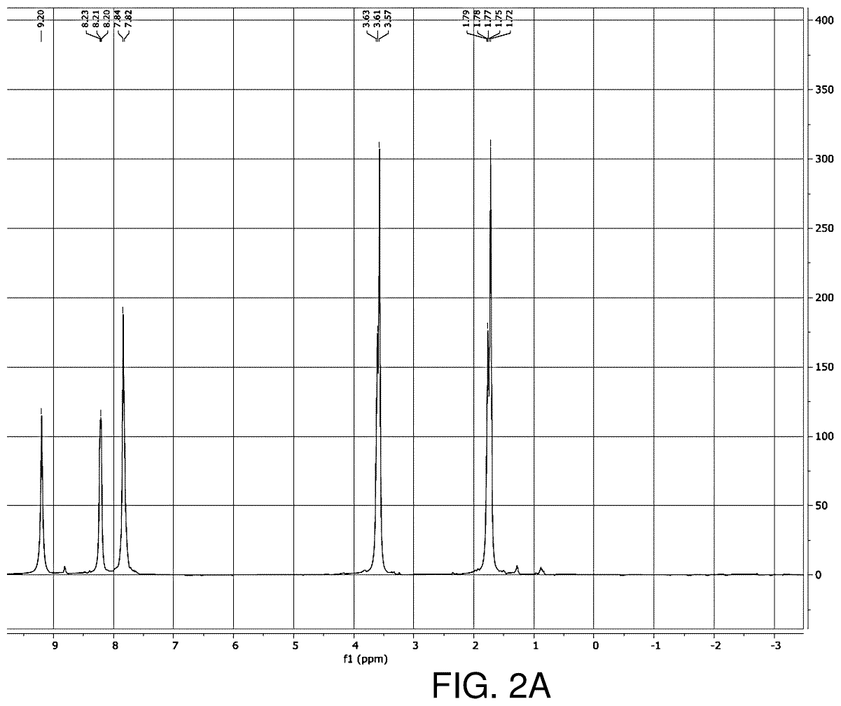

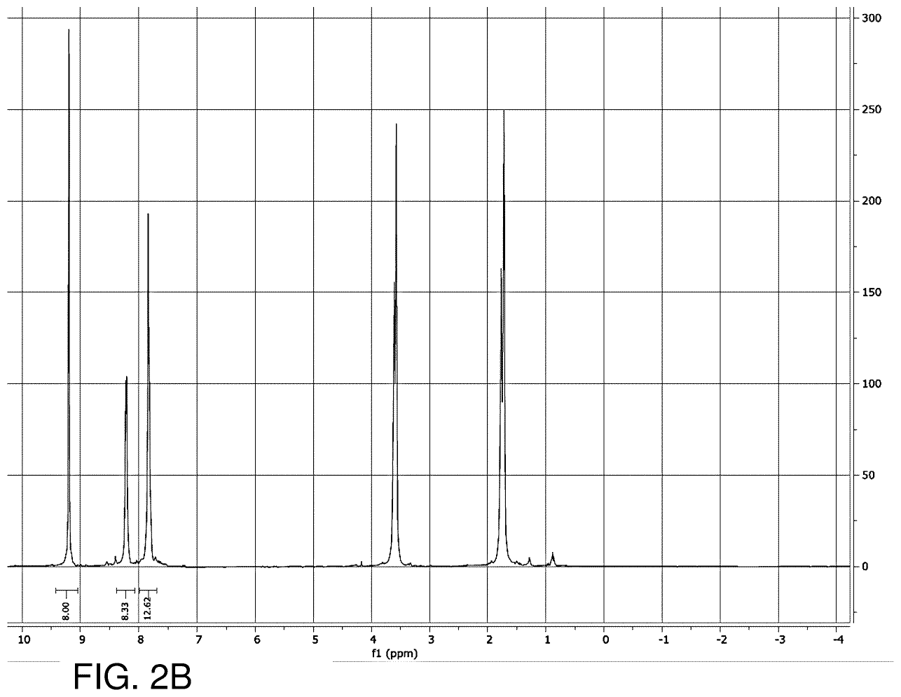

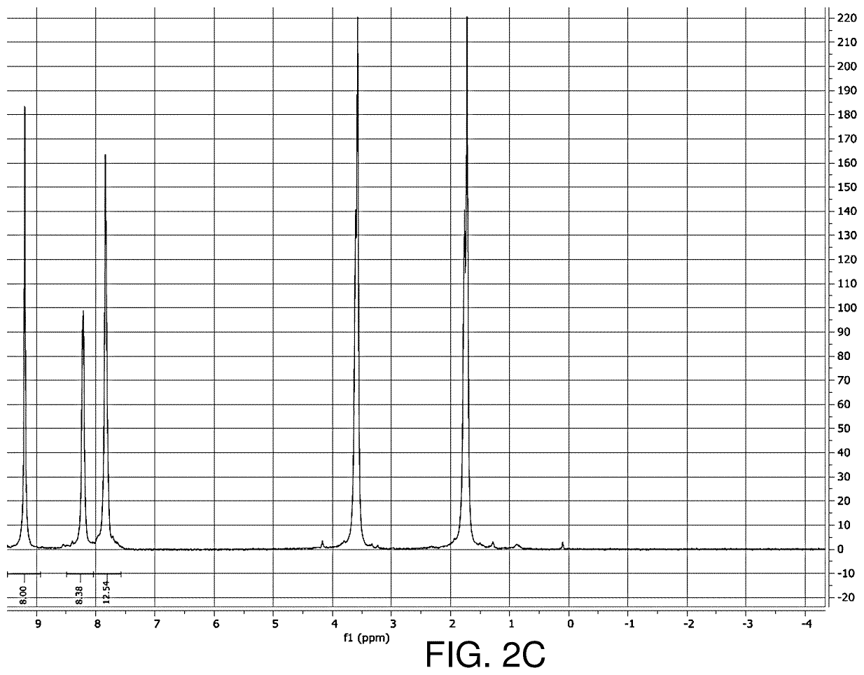

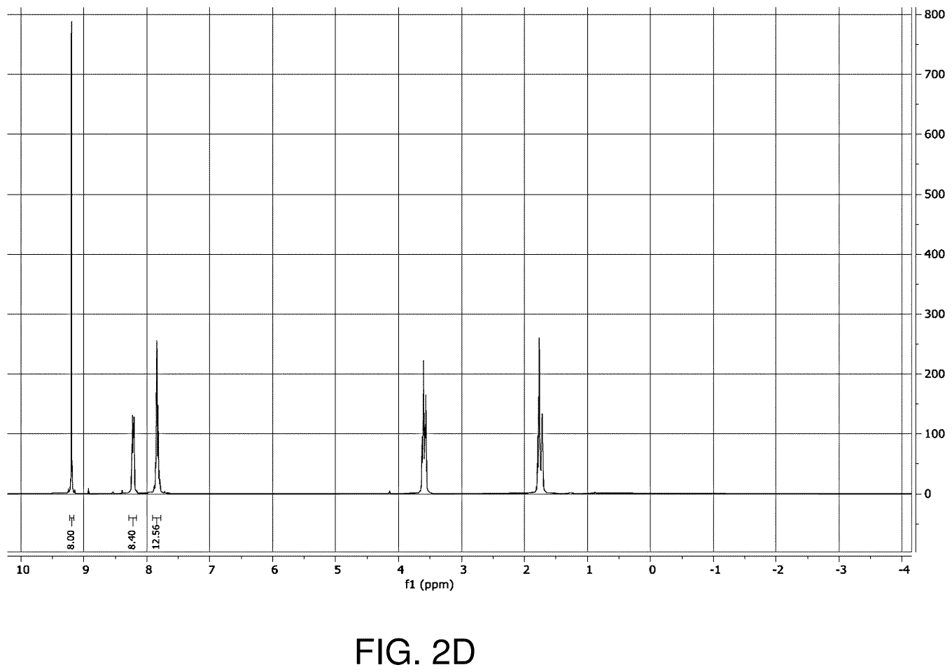

FIG. 2A is a 1H NMR spectrum of the isolated carbonylation catalyst of Examples 1-3 that is formed by the disclosed method. This is analyzed in d8-THF.

FIG. 2B is a 1H NMR spectrum of the isolated carbonylation catalyst of Examples 4-9 that is formed by another method of forming the catalyst. This is analyzed in d8-THF.

FIG. 2C is a 1H NMR spectrum of the isolated carbonylation catalyst of Examples 9 that is formed by the disclosed method. This is analyzed in d8-THF.

FIG. 2D is a 1H NMR spectrum of the isolated carbonylation catalyst of Examples 10-12 that is formed by the disclosed method. This is analyzed in d8-THF.

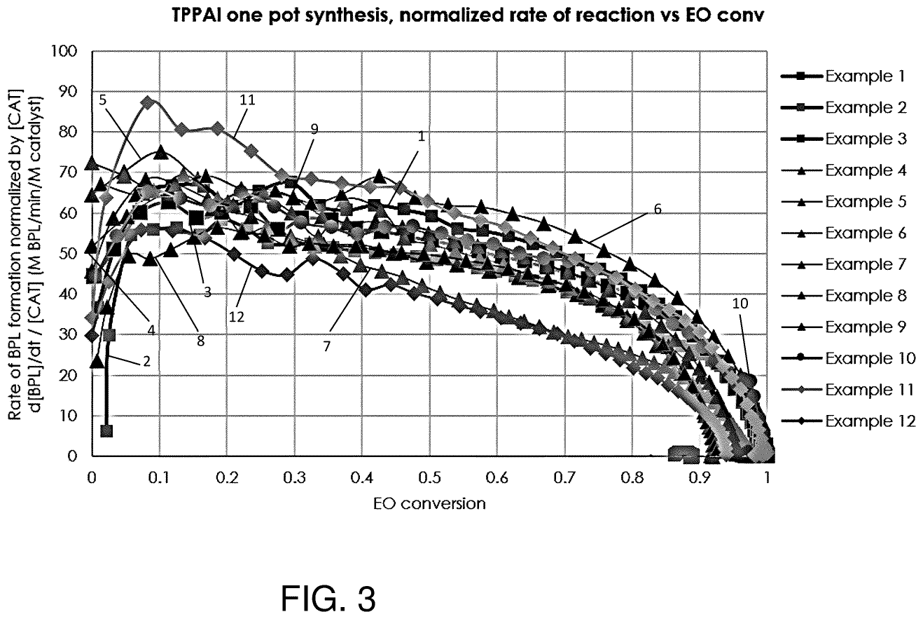

FIG. 3 is a graph showing the catalytic activity of the carbonylation catalysts made from the processes described herein and the catalytic activity of the carbonylation catalysts made from another method.

### DETAILED DESCRIPTION

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

One or more as used herein means that at least one, or more than one, of the recited components may be used as disclosed. Residue with respect to an ingredient or reactant used to prepare the polymers or structures disclosed herein means that portion of the ingredient that remains in the polymers or structures after inclusion as a result of the methods disclosed herein. Substantially or substantial as used herein means that greater than 90 percent of the referenced parameter, composition, structure or compound meet the defined criteria, greater than 95 percent, greater than 99 percent of the referenced parameter, composition or compound meet the defined criteria, or greater than 99.5 percent of the referenced parameter, composition or compound meet the defined criteria. Substantially free as used herein means that the reference parameter, composition, structure, or compound contains about 10 percent or less, about 5 percent or less, about 1 percent or less, about 0.5 percent or less, or about 0.1 percent or less. Portion as used herein means less than the full amount or quantity of the component in the composition, stream, or both. Precipitate as used herein means a solid compound in a slurry or blend of liquid and solid compounds. The ingredients or products may exist in different states during the processes disclosed such as solid, liquid, or gaseous. Phase refers to a portion of a reaction mixture that is not soluble in another part of the reaction mixture. The dispersions and slurries disclosed herein may comprise multiple phases. Particular ingredients and products may be in different states and phases at the same time of the process and at different times of the process. Slurries and dispersions comprise solid ingredients dispersed in liquid ingredients, products and/or solvents. Parts per weight means parts of a component relative to the total weight of the overall composition. A catalyst component as used herein means a metalated ligand complex, a metal carbonyl, a Lewis acid, a Lewis acid derivative, a metal carbonyl derivative, or any combination thereof. A catalyst or carbonylation catalyst as used herein includes at least a cationic compound and an anionic compound. Composition or mixture as used herein includes all components in a stream, reactant stream, product stream, slurry, precipitate, solution, liquid, solid, gas, or any combination thereof that are containable within a single vessel. In other words, the mixture may include components that are solid, gaseous (i.e., volatile), and/or liquid when at room temperature (i.e., 25 degrees Celsius). Heteroatom means nitrogen, oxygen, sulfur and phosphorus, more preferred heteroatoms include nitrogen and oxygen. Hydrocarbyl as used herein refers to a group containing one or more carbon atom backbones and hydrogen atoms, which may optionally contain one or more heteroatoms. Where the hydrocarbyl group contains heteroatoms, the heteroatoms may form one or more functional groups well known to one skilled in the art. Hydrocarbyl groups may contain cycloaliphatic, aliphatic, aromatic or any combination of such segments. The aliphatic segments can be straight or branched. The aliphatic and cycloaliphatic segments may include one or more double and/or triple bonds. Included in hydrocarbyl groups are alkyl, alkenyl, alkynyl, aryl, cycloalkyl, cycloalkenyl, alkaryl and aralkyl groups. Cycloaliphatic groups may contain both cyclic portions and noncyclic portions. Hydrocarbylene means a hydrocarbyl group or any of the described subsets having more than one valence, such as alkylene, alkenylene, alkynylene, arylene, cycloalkylene, cycloalkenylene, alkarylene and aralkylene. One or both hydrocarbyl groups may consist of one or more carbon atoms and one or more hydrogen atoms.

Disclosed herein are compounds useful as carbonylation catalysts. The methods used to prepare such compounds start with a ligand complex, a metalation compound, and a metal carbonyl to form a carbonylation catalyst, which may be performed without isolating any intermediates before yielding the carbonylation catalyst. The reaction can be completed all within the same reaction vessel. For example, contacting the metalation compound and the ligand complex in a hydrocarbon solvent forms a metalated ligand complex. After forming the metalated ligand complex, the metal carbonyl and polar solvent can simply be added to the reaction mixture to yield a carbonylation catalyst, without isolating any intermediate compounds, such as the metalated ligand complex. After forming the carbonylation catalyst, the reaction mixture of ingredients and products can be subjected to a known method for separating solids from liquids, for example gravity filtration, to yield the carbonylation catalyst in a form that is sufficient to catalyze a carbonylation reaction (i.e., formation of a lactone) or other similar ring opening reaction (i.e., formation of a lactam).

The carbonylation catalysts formed by the techniques described herein may contain impurities, nevertheless the carbonylation catalyst has high catalytic activity to form lactones and/or lactams without further purification. The methods can be performed by mixing all of the ingredients in a single vessel, which can then be subjected to a known method of separating solids from liquids, such as filtration, to recover a carbonylation catalyst with molar yields of upwards of 90 percent or more. Because no intermediates need to be filtered or isolated, the solvents used can be limited to just what is needed to perform the reaction steps, until the carbonylation catalyst is formed as a precipitate and separated from the reaction mixture (i.e., slurry), which reduces the amount of solvent used in the process and reduces the amount of time spent synthesizing and isolating compounds.

The ligand complex may function to bind with a metal so that a metalated ligand complex is formed. The ligand complex may have any structure sufficient to assist with formation of a lactam and/or lactone when the ligand complex is integrated with a metal and, subsequently, into a carbonylation catalyst. The ligand complex may be aromatic so that ligand complex is completely conjugated and/or the carbonylation catalyst has conjugation in a portion of the structure. The ligand complex may include aromatic groups. The ligand complex may include one or more of a phosphine, an imine, or an amine group bound to a cyclic structure. A cyclic structure may include atoms bound together so as to form a continuous loop of atoms. The ligand complex may include one or more macrocycles. The ligand complex may include one or more substituted portions that are configured to improve steric and/or electronic properties of the carbonylation catalyst that is formed from the ligand complex. The ligand complex may be formed by one or more methods included in co-pending US Provisional Application Nos. 63/171,150 (filed on Apr. 6, 2021); 63/220,126 (filed on Jul. 9, 2021); and/or 63/171,152 (filed on Apr. 6, 2021), US Publication No. 2017/0225157 (filed on Jul. 24, 2017), and/or U.S. Pat. Nos. 9,327,280 and 8,921,581, which are each incorporated herein in their entirety. Examples of the ligand complexes may include complexes corresponding to the following formulas:

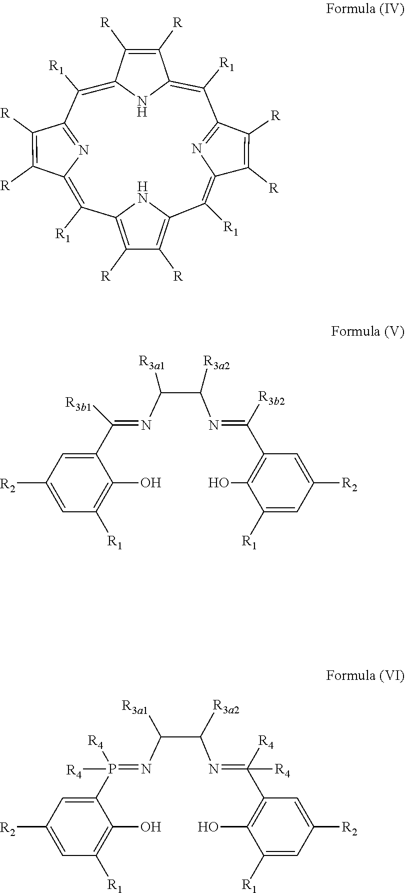

where M may be selected from aluminum, chromium, gallium, indium, zinc, copper, manganese, cobalt, ruthenium, iron, rhenium, nickel, palladium, magnesium, titanium, or any combination thereof,
where each R may independently at each occurrence include hydrogen, halogen, —OR⁴, —NR^{y}₂, —SR, —CN, —NO₂, —SO₂R^{y}, —SOR^{y}, —SO₂NR^{y}₂; —CNO, —NRSO₂R^{y}, —NCO, —N₃, —SiR₃; or an optionally substituted group selected from the group consisting of C₁₋₂₀aliphatic; C₁₋₂₀ heteroaliphatic having 1-4 heteroatoms independently selected from the group consisting of nitrogen, oxygen, and sulfur; 6 to 10 membered aryl; 5 to 10 membered heteroaryl having 1 to 4 heteroatoms independently selected from nitrogen, oxygen, or sulfur; and 4 to 7 membered heterocyclic having 1 to 2 heteroatoms independently selected from the group consisting of nitrogen, oxygen, and sulfur, where two or more R^{d} groups may be taken together to form one or more optionally substituted rings, and each R^{y} is independently hydrogen, or an optionally substituted group selected the group consisting of: acyl; carbamoyl, arylalkyl; 6 to 10 membered aryl; C₁₋₁₂ aliphatic; C₁₋₁₂ heteroaliphatic having 1 to 2 heteroatoms independently selected from the group consisting of nitrogen, oxygen, and sulfur; 5 to 10 membered heteroaryl having 1 to 4 heteroatoms independently selected from the group consisting of nitrogen, oxygen, and sulfur; 4 to 7 membered heterocyclic having 1 to 2 heteroatoms independently selected from the group consisting of nitrogen, oxygen, and sulfur; an oxygen protecting group; and a nitrogen protecting group; where two R^{y} on the same nitrogen atom may be taken with the nitrogen atom to form an optionally substituted 4 to 7 membered heterocyclic ring having 0 to 2 additional heteroatoms independently selected from the group consisting of nitrogen, oxygen, and sulfur.
where each R₁ may be a group independently selected from one or more of hydrogen, halogen, heteroaliphatic, heterocyclic, heteroaromatic, alkyl, alkoxide, aryl, silyl alkyl, alkyl-aryl, amine, trifluoromethyl, nitro, hydrocarbyl oxy, derivatives thereof, substituted groups thereof, or any combination thereof,
where each R₂ may be a group independently selected from one or more of hydrogen, alkyl, alkoxide, aryl, silyl alkyl, alkyl-aryl, amine, trifluoromethyl, nitro, hydrocarbyl oxy, derivatives thereof, substituted groups thereof, or any combination thereof.
where R₃ₐ₁ and/or R₃ₐ₂ may be independently selected from one or more of hydrogen, methyl, a C₂₋₁₀ alkyl chain, a combination thereof, or in combination form a cyclohexane or a phenyl group that is optionally substituted. The substituted groups may include aromatic groups, aliphatic groups, or both.
where R_{3b1} and/or R_{3b2} may be independently selected from one or more of hydrogen, methyl, a C₂₋₁₀ alkyl chain, or a combination thereof. where R₃ₐ₁ and R_{3b1} may in combination form one or more of a heterocyclic compound, a heterocyclic ring having one or more substitutions, a cyclic structure, any combination thereof.

R₃ₐ₁ and R_{3b1} may in combination form a six membered ring that is optionally substituted, aromatic, or both. A heterocyclic ring may include pyridine, a pyridine having one or more substitutions, or any combination thereof.
where R₃ₐ₂ and R_{3b2} may in combination form one or more of a pyridine, a pyridine having one or more substitutions, a cyclic structure, any combination thereof. R₃ₐ₂ and R_{3b2} may in combination form a six membered ring that is optionally substituted, aromatic, or both. where independently one of the R₄ groups and R₃ₐ₁ and/or R₃ₐ₂ may in combination each independently form one or more of a cyclic structure. The cyclic structure may include one or more of a heterocyclic compound, an aromatic compound, or any combination thereof. The cyclic structure may include one or more of cyclohexane, a phenyl group, a pyridine, or any combination thereof.

The metal carbonyl of the carbonylation catalyst functions to provide the anionic component of the carbonylation catalyst. The carbonylation catalyst may include one or more, two or more, or a combination of metal carbonyls. The metal carbonyl may be capable of ring-opening an epoxide and facilitating the insertion of CO into the resulting metal carbon bond. The metal carbonyl may include an anionic metal carbonyl moiety. In other examples, the metal carbonyl compound may include a neutral metal carbonyl compound. The metal carbonyl may include a metal carbonyl hydride compound. The metal carbonyl may be a pre-catalyst which reacts in situ with one or more reaction components to provide an active species different from the compound initially provided. The metal carbonyl includes an anionic metal carbonyl species. The metal carbonyl may have the general formula Q_{d}[M′ₑ(CO)_{w}]^{y}, where Q may include one or more of hydrogen, an alkaline metal, or a combination of both. Q may be optional. M′ is a metal atom, d is an integer between 0 and 8 inclusive, e is an integer between 1 and 6 inclusive, w is a number such as to provide the stable anionic metal carbonyl complex, and y is the charge of the anionic metal carbonyl species. y may be positive, negative, or neutral. The metal carbonyl may include monoanionic carbonyl complexes of metals from groups 5, 7 or 9 of the periodic table or dianionic carbonyl complexes of metals from groups 4 or 8 of the periodic table. The metal carbonyl may contain titanium, vanadium, iron, chromium, osmium, rhenium, technetium, cobalt, manganese, ruthenium, rhodium, or any combination thereof. Exemplary metal carbonyls may include [CO(CO)₄]⁻, [Ti(CO)e]²⁻, [V(CO)₆]⁻, [Rh(CO)₄]⁻, [Fe(CO)₄]²⁻, [Ru(CO)₄]²⁻, [Os(CO)₄]²⁻, [Cr₂(CO)₁₀]²⁻, [Fe₂(CO)₈]²⁻, [Tc(CO)₅]⁻, [Re(CO)₅]⁻, [Mn(CO)₅]⁻, or any combination thereof. The metal carbonyl may include a mixture of two or more anionic metal carbonyl complexes in the carbonylation catalysts used in the methods. The metal carbonyl may include a salt. The metal carbonyl may include NaCo(CO)₄, CO₂(CO)₈, HCo(CO)₄, or any combination thereof.

The metalation compound may function to coordinate a metal in one or more ligands to form a metalated ligand complex containing a halogen and/or an alkyl group. The metalation compound may include any compound containing a metal and/or one or more alkyl groups and/or halogen groups. The metalation compound may include any compound capable of coordinating one or more metals to a ligand complex. The metal of the metalation compound may include one or more of aluminum, chromium, zinc, zirconium, or any combination thereof. The metalation compound may have a structure according to M(L)ⱼ, where M corresponds to a metal, L corresponds to an alkyl and/or halogen compound, and j is an integer from 1 to 3. The metalation compound may include a metal that is trisubstituted or disubstituted. The metalation compound may include a metal that is trisubstituted or disubstituted with one or more of an alkyl group, a halogen group, a hydrogen, or any combination thereof. The metalation compound may include a trialkyl metal compound, a trihalogenated metal compound, a dihalogenated metal compound, or any combination thereof. The metalation compound may include one or more of CrCl₂, (Et)₂AlCl, AlEt₃, AlⁱBu₃, AlMe₃, or any combination thereof.

In some metalated ligand complexes and/or catalysts, one or more polar ligands may coordinate to the metal atom positioned within the ligand complex and fill the coordination valence of the metal atom. The polar ligand may coordinate to the metalated ligand complex after the metal binds to the ligand complex. The polar ligand may be a polar solvent that has the dual function of coordinating to the metal complex and dissolving one or more components that are dissolvable in the polar solvent. The polar ligand may be any compound with at least two free valence electrons. The polar ligand may be a polar aprotic compound. The polar ligand may include ethers, heterocyclic compounds containing nitrogen, nitriles, esters, ketones, acetates, or any combination thereof. The ethers may be cyclic ethers or dialkyl ethers. The polar ligand may be tetrahydrofuran, dioxane, diphenyl ether, methyl tert-butyl-ether, ethyl acetate, 2-butanone, diethyl ether, or a combination thereof.

The metalated ligand complex may function to be the cationic component of a carbonylation catalyst. The metalated ligand complex may be any compound sufficient to bind with a metal carbonyl and/or polar ligand to form a carbonylation catalyst. The metalated ligand complex may be any compound containing at least one metal and at least one ligand complex. The metalated ligand complex may be any compound configured to coordinate with a polar ligand, form a cation, and bind with one or more metal carbonyls so that the catalyst is formed. The metalated ligand complex may contain one or more portions that assist with dissolving in a polar and/or a hydrocarbon solvent. The metalated ligand complex may include one or more compounds described in co-pending US Provisional Application Nos. 63/171,150 (filed on Apr. 6, 2021); 63/220,126 (filed on Jul. 9, 2021); and/or 63/171,152 (filed on Apr. 6, 2021), US Publication No. 2017/0225157 (filed on Jul. 24, 2017), and/or U.S. Pat. Nos. 9,327,280 and 8,921,581, which are each incorporated herein in their entirety.

The polar solvent functions to dissolve one or more compounds having polar portions. The polar solvent may include at least one heteroatom. The polar solvent may be a polar aprotic solvent. The polar solvent may be a compound with at least two free valence electrons. For example, the polar solvent may include one or more ester solvents, ketone solvents, aldehyde solvents, ether solvents, or any combination thereof. The polar solvent may be configured to dissolve one or more compounds with polar portions and/or coordinate to a metalated ligand complex or a carbonylation catalyst. The polar solvent may include sulfur, nitrogen, oxygen, carbon, hydrogen, a halogen, or any combination thereof. The polar solvent may include heterocyclic compounds containing nitrogen, ethers, nitriles, esters, ketones, acetates, or any combination thereof. The polar solvent may be tetrahydrofuran, dioxane, diphenyl ether, methyl tert-butyl-ether, ethyl acetate, 2-butanone, diethyl ether, or a combination thereof.

The hydrocarbon solvent functions to dissolve one or more compounds having nonpolar elements. The hydrocarbon solvents may be free of any heteroatoms and/or free valence electrons. In other words, the hydrocarbon solvents may include only a combination of carbon and hydrogen. The hydrocarbon solvent may include one or more cyclic and/or linear portions. The hydrocarbon solvent may include alkyl and/or aryl portions. The hydrocarbon solvent may include unsaturated portions or may be completely saturated. The hydrocarbon solvent may include cyclic carbon compounds that are saturated or unsaturated, linear carbon compounds that are saturated or unsaturated. The hydrocarbon solvent may include about 3 to about 20 carbons. For example, the hydrocarbon solvent may include one or more of pentane, hexane, heptane, cycloheptane, cyclohexane, benzene, xylene, toluene, or any combination thereof.

The hydrocarbon and/or polar solvents may be used in combination where the solvents are miscible with each other. For example, one solvent may be soluble in one or more other solvents to increase solubility of one or more of the compounds described herein. Specifically, a first solvent may be combined with a second solvent that is miscible in the first solvent, and heat may be applied to dissolve a solid compound. Then the first and second solvents that have dissolved the solid compounds may be cooled (e.g., with an ice bath) to crystalize and precipitate the dissolved compound in a higher purity than when it was originally dissolved. In this example, the combination of first and second solvents may provide a method to separate the carbonylation catalyst from undesirable impurities. The reaction steps disclosed herein may be performed under conditions such that one or more of the ingredients, unrecovered intermediates or products saturate the portion of the reaction mixtures wherein the reactions described take place and the rate limiting features of the reaction relate to the solubility of the particular ingredients, unrecovered intermediates or products in such reaction medium. The amount of heat, choice of solvents and ratios of solvents can be adjusted to increase or decrease the solubility of the ingredients, unrecovered intermediates or products in the reaction medium to solubility of ingredients, unrecovered intermediates or products to assist in moving the reactions toward the desired intermediates and product of each reaction step.

Impurities with a carbonylation catalyst as described herein may include a multitude of compounds that are separate from metalated ligand complex bound to the metal carbonyl. The impurities may be any compound formed by a side reaction and/or are unreacted starting reagents. The impurities may be any compound except for the catalyst, which is the metalated ligand complex containing one or more polar ligand and bound to the metal carbonyl. For example, the impurities may include one or more of the polar solvent, the hydrocarbon solvent, the metal carbonyl, the metalation compound, the ligand complex, alkyl compounds (e.g., butene and/or butane), carbonyl (e.g., 3-pentanone), any unbound metalated ligand complex, or any combination thereof. The impurities may be removed if one or more of the impurities interfere or slow the reactivity of the carbonylation catalyst or undesirably interact with one or more components in a reaction. The impurities may be removed through additional separation steps known by the skilled artisan when desired.

The carbonylation catalyst may be a combination of an anionic compound and a cationic compound. For example, the carbonylation catalyst may be a metalated ligand compound that is cationic and ionically bound with a metal carbonyl that is anionic. The carbonylation catalyst may include one or more other polar ligands coordinated to the metal of the metalated ligand compound so that the polar solvent used herein may have a dual purpose (i.e., facilitating the reaction and coordinating to the metal). The carbonylation catalyst may include at least two metal compounds that are ionically bound together. For example, an aluminum integrated with a ligand complex may be ionically bound to a cobalt carbonyl. The carbonylation catalyst may include any metal that is contained within the metalated ligand complex, the metal carbonyl, or both. The carbonylation catalyst may be any catalyst containing a metal center and having catalytic activity with one or more of an epoxide, a lactone, an aziridine, a lactam or any combination thereof. The metal of the cationic or anionic component of the carbonylation catalyst may be any metal sufficient to catalyze a carbonylation or ring opening reaction. The carbonylation catalyst may have one or more structures shown in US Provisional Application Nos. 63/171,150 (filed on Apr. 6, 2021); 63/220,126 (filed on Jul. 9, 2021); and/or 63/171,152 (filed on Apr. 6, 2021), US Publication No. 2017/0225157 (filed on Jul. 24, 2017), and/or U.S. Pat. Nos. 9,327,280 and 8,921,581, which are each incorporated herein by reference in their entirety. For example, the carbonylation catalyst may have a structure according to the following formulas:

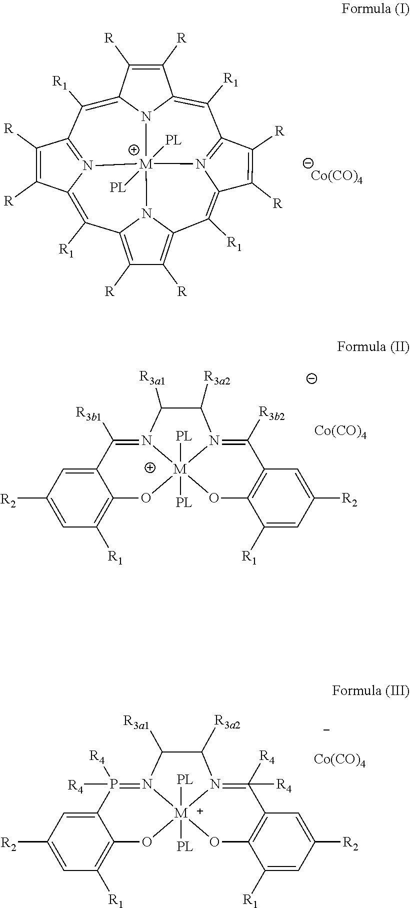

where M may be selected from aluminum, chromium, gallium, indium, zinc, copper, manganese, cobalt, ruthenium, iron, rhenium, nickel, palladium, magnesium, titanium, or any combination thereof.
where each R may independently at each occurrence include hydrogen, halogen, —OR⁴, —NR^{y}₂, —SR, —CN, —NO₂, —SO₂R^{y}, —SOR^{y}, —SO₂NR^{y}₂; —CNO, —NRSO₂R^{y}, —NCO, —N₃, —SiR₃; or an optionally substituted group selected from the group consisting of C₁₋₂₀aliphatic; C₁₋₂₀ heteroaliphatic having 1-4 heteroatoms independently selected from the group consisting of nitrogen, oxygen, and sulfur; 6 to 10 membered aryl; 5 to 10 membered heteroaryl having 1 to 4 heteroatoms independently selected from nitrogen, oxygen, or sulfur; and 4 to 7 membered heterocyclic having 1 to 2 heteroatoms independently selected from the group consisting of nitrogen, oxygen, and sulfur, where two or more R^{d} groups may be taken together to form one or more optionally substituted rings, and each R^{y} is independently hydrogen, or an optionally substituted group selected the group consisting of: acyl; carbamoyl, arylalkyl; 6 to 10 membered aryl; C₁₋₁₂ aliphatic; C₁₋₁₂ heteroaliphatic having 1 to 2 heteroatoms independently selected from the group consisting of nitrogen, oxygen, and sulfur; 5 to 10 membered heteroaryl having 1 to 4 heteroatoms independently selected from the group consisting of nitrogen, oxygen, and sulfur; 4 to 7 membered heterocyclic having 1 to 2 heteroatoms independently selected from the group consisting of nitrogen, oxygen, and sulfur; an oxygen protecting group; and a nitrogen protecting group; where two R^{y} on the same nitrogen atom may be taken with the nitrogen atom to form an optionally substituted 4 to 7 membered heterocyclic ring having 0 to 2 additional heteroatoms independently selected from the group consisting of nitrogen, oxygen, and sulfur.
where each R₁ may be a group independently selected from one or more of hydrogen, halogen, heteroaliphatic, heterocyclic, heteroaromatic, alkyl, alkoxide, aryl, silyl alkyl, alkyl-aryl, amine, trifluoromethyl, nitro, hydrocarbyl oxy, derivatives thereof, substituted groups thereof, or any combination thereof.
where each R₂ may be a group independently selected from one or more of hydrogen, alkyl, alkoxide, aryl, silyl alkyl, alkyl-aryl, amine, trifluoromethyl, nitro, hydrocarbyl oxy, derivatives thereof, substituted groups thereof, or any combination thereof.
where R₃ₐ₁ and/or R₃ₐ₂ may be independently selected from one or more of hydrogen, methyl, a C₂₋₁₀ alkyl chain, a combination thereof, or in combination form a cyclohexane or a phenyl group that is optionally substituted. The substituted groups may include aromatic groups, aliphatic groups, or both.
where R_{3b1} and/or R_{3b2} may be independently selected from one or more of hydrogen, methyl, a C₂₋₁₀ alkyl chain, or a combination thereof.
where R₃ₐ₁ and R_{3b1} may in combination form one or more of a heterocyclic compound, a heterocyclic ring having one or more substitutions, a cyclic structure, any combination thereof.

R₃ₐ₁ and R_{3b1} may in combination form a six membered ring that is optionally substituted, aromatic, or both. A heterocyclic ring may include pyridine, a pyridine having one or more substitutions, or any combination thereof.
where R₃ₐ₂ and R_{3b2} may in combination form one or more of a pyridine, a pyridine having one or more substitutions, a cyclic structure, any combination thereof. R₃ₐ₂ and R_{3b2} may in combination form a six membered ring that is optionally substituted, aromatic, or both. where independently one of the R₄ groups and R₃ₐ₁ and/or R₃ₐ₂ may in combination each independently form one or more of a cyclic structure. The cyclic structure may include one or more of a heterocyclic compound, an aromatic compound, or any combination thereof. The cyclic structure may include one or more of cyclohexane, a phenyl group, a pyridine, or any combination thereof.

The carbonylation catalyst may be any catalyst containing a metal center and having catalytic activity with one or more of an epoxide, a lactone, an aziridine, a lactam or any combination thereof. The catalyst may be utilized in a carbonylation reaction to form a lactone. The carbonylation reaction may include contacting one or more epoxides, lactones, or both with carbon monoxide in the presence of catalyst. This step may occur in a reactor that has one or more inlets, two or more inlets, three or more inlets, or a plurality of inlets. The one or more epoxides, the lactones, the carbon monoxide, and the catalyst may be added in a single inlet, multiple inlets, or each may be added in a separate inlet as separate or combined feed streams. The carbonylation reaction may produce one or more product streams or compositions through one or more outlets.

The epoxide used in the carbonylation reaction may be any cyclic alkoxide containing at least two carbon atoms and one oxygen atom. For example, the epoxide may have a structure shown by formula (VII):

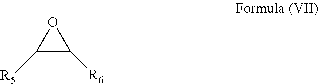

where R₅ and R₆ are each independently selected from the group consisting of: a hydrocarbyl group or hydrogen wherein the hydrocarbyl group may contain one or more heteroatoms with the proviso that the hydrocarbyl group does not negatively impact the catalytic activity of the ligand complexes formed. The hydrocarbyl may be an alkyl or aryl group. R₅ and R₆ can optionally be taken together with intervening atoms to form a 3 to 10 membered, substituted or unsubstituted ring optionally containing one or more heteroatoms; or any combination thereof.

The lactone formed from the carbonylation reaction may be any cyclic carboxylic ester having at least one carbon atom and two oxygen atoms. For example, the lactone may be an, β-propiolactone, β-butyrolactone, and β-valerolactone, or a combination thereof. Anywhere in this application where a propiolactone or lactone is used or described, another lactone may be applicable or usable in the process, step, or method. Where a propiolactone is a used or produced in the carbonylation reaction, the propiolactone may have a structure corresponding to formula V:

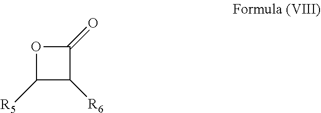

where R₅ and R₆ are each independently selected from the group consisting of: a hydrocarbyl group or hydrogen wherein the hydrocarbyl group may contain one or more heteroatoms with the proviso that the hydrocarbyl group does not negatively impact the catalytic activity of the ligand complexes formed. The hydrocarbyl may be an alkyl or aryl group. R₅ and R₆ can optionally be taken together with intervening atoms to form a 3 to 10 membered, substituted or unsubstituted ring optionally containing one or more heteroatoms; or any combination thereof.

The product stream from the carbonylation reaction may include one or more of a propiolactone, a polypropiolactone, succinic anhydride, polyethylene glycol, poly-3-hydroxypropionate, 3-hydroxy propionic acid, 3-hydroxy propionaldehyde, a polyester, a polyethylene, a polyether, unreacted epoxides, any derivative thereof, any other monomer or polymer derived from the reaction of an epoxide and carbon monoxide, any starting reagent of the catalyst formation, any side product of the catalyst formation, any derivative thereof, or any combination thereof. The product stream may include one or more inorganic compounds that include catalyst components such as metal carbonyls, metalated ligand complexes, ligand complexes, or any combination thereof. The product stream may include a carbonylation catalyst that has not been spent or used up in the process of forming lactones. The product stream may include one or more of unreacted epoxides or carbon monoxide.

To begin formation of the carbonylation catalyst from a ligand complex, the reaction may comprise three steps that may be performed in a single vessel or multiple vessels using minimal solvents and isolation steps. As used herein, a reaction mixture includes the first mixture that relates to the first step and second mixture that related to the second step. In a first step, the ligand complex and a metalation compound may be contacted with or dissolved in a hydrocarbon solvent to form a first mixture. The first step may yield a metalated ligand complex from reaction of the metalation compound and the ligand complex that does not need to be isolated before a second step. After a period of time with mixing, a polar solvent and a metal carbonyl may be contacted with the first mixture from the first step in the second step with mixing for a sufficient period of time to form a second mixture. In the second step, the carbonylation catalyst may be comprised of a combination of the metal carbonyl and the metalated ligand complex. The carbonylation catalyst that is formed may precipitate from the second mixture in the second step to form a slurry. In a third step, the carbonylation catalyst may be separated from the slurry or suspension by any known means to yield a carbonylation catalyst that is solid, and the remaining components (e.g., unreacted starting components, byproducts, solvents, or the like) may remain in the second mixture along with the hydrocarbon and/or polar solvents. The carbonylation catalyst with this method may be formed with a high molar yield, minimal interfering impurities, and have desirable catalytic activity, without additional purification or isolation techniques. The carbonylation catalyst may be subject to additional steps if it is desirable to remove substantially all of the impurities that may be present.

In the first step, the ligand complex and the metalation compound are contacted in a hydrocarbon solvent to form the metalated ligand complex within a first mixture. The entire reaction in the first step may be performed without any isolation of intermediates or isolation before proceeding to the second step. The entire reaction in the first step may be performed in a vessel that is free of moisture, air, and/or oxygen so that the oxygen and/or moisture does not have undesirable interactions with the ligand complex, metalation compound, metalated ligand complex, or carbonylation catalyst. For example, the reaction may be performed under an inert atmosphere, in a dry box, and/or a Schlenk line. The reaction vessel(s) may contain one or more reaction zones, and may include, a batch reactor, a continuous stirred-tank reactor, a plug flow reactor, semi-batch reactor, a catalytic reactor, a continuous flow reactor, or any combination thereof. The vessel may be equipped with a mechanism for mixing the reaction, such as an agitator, impeller, or a combination of both. In other examples, the reaction may be mixed by the flow of fluids within a reactor, such as sparging or turbulent flow.

The ligand complex and the metalation compound may be contacted in any molar ratio sufficient to form a metalated ligand complex. An excess of the metalation compound may reduce the amount of unreacted ligand complex after formation of the metalated ligand complex. The metalation compound and the ligand may be contacted in a molar ratio of about 1:1 or more, about 1.1:1 or more, or about 1.2:1 or more. The molar ratio may be about 1.5:1 or less, about 1.4:1 or less, or about 1.3:1 or less. The ligand complex and/or the metalation compound may be added to the single vessel in any form sufficient to form the first mixture where a metalated ligand compound is formed. For example, the ligand complex and/or the metalation compound may be a solid (i.e., when not mixed with a hydrocarbon before entry into the reaction vessel), a liquid (i.e., when first dissolved in a hydrocarbon before entry into the reaction vessel), or in neat form. Where the ligand complex and/or metalation compound are added in a solid form, the ligand complex and/or metalation compound may simply be added to the vessel via adding an amount in a form that is solid and sufficient to react and form the metalated ligand compound. In other examples where the ligand complex and/or the metalation compound are first in liquid form before addition to the vessel, the ligand complex and/or metalation compound may be added to the vessel via a feed line, pipe, tube, or any combination thereof. The metalation compound and/or ligand complex may be added with techniques that keep oxygen, air, and/or moisture out of the first mixture.

The ligand complex may be dissolved by the hydrocarbon solvent first to form a first mixture, and the metalation compound may be dissolved in the first mixture second so that a reaction ensues to form the metalated ligand complex. The ligand complex may be mixed for any period of time to partially dissolve the ligand complex within the hydrocarbon solvent. For example, the ligand complex may be mixed with the hydrocarbon solvent for about 30 seconds or more, about 3 minutes or more, or about 5 minutes or more. The ligand complex may be mixed with the hydrocarbon solvent for about 20 minutes or less, about 15 minutes or less, or about 10 minutes or less.

The metalation compound may be contacted with the hydrocarbon solvent to form a first mixture, and the ligand complex may be contacted with the first mixture second so that a reaction ensues to form the metaled ligand complex. The metalation compound may be mixed for any period of time to partially or fully dissolve the metalation compound within the polar solvent and/or hydrocarbon solvent. For example, the metalation compound may be mixed for about 30 seconds or more, about 3 minutes or more, or about 5 minutes or more. The metalation compound may be mixed for about 20 minutes or less, about 15 minutes or less, or about 10 minutes or less.

The first mixture of hydrocarbon solvent, metalation compound, and/or ligand complex may be mixed for any period of time sufficient to form a metaled ligand complex. For example, the first mixture may be mixed for about 0.5 hour or more, about 1.5 hours or more, or about 3.5 hours or more. The first mixture may be mixed for about 7 hours or less, about 6 hours or less, or about 5 hours or less. During the mixing of the reaction, the first mixture may be heated at any temperature sufficient to form the metalated ligand complex and without affecting the stability of the metalated ligand complex. For example, the first mixture may be heated at about 40 degrees Celsius or more, about 60 degrees Celsius or more, or about 80 degrees Celsius or more. The first mixture may be heated at about 140 degrees Celsius or less, about 120 degrees Celsius or less, or about 100 degrees Celsius or less.

After contacting the ligand complex and the metalation compound within the hydrocarbon solvent, a first mixture formed may be a slurry, suspension, and/or solution. After contacting the ligand complex and the metalation compound within the hydrocarbon solvent to form a first mixture, a polar solvent may be contacted with the mixture. The metalated ligand complex may be fully formed before addition of the polar solvent. Addition of the polar solvent may partially dissolve any solid components (e.g., the metaled compound, ligand complex, and/or metaled ligand complex) within the second mixture (i.e., in the case of the of a slurry). The polar solvent may have a portion that coordinates to the metalated ligand complex so that the metal of the metalated ligand complex includes two or more molecules of the polar solvent in the form of polar ligands.

The polar solvent and the first mixture containing the metalated ligand complex and hydrocarbon solvent may be contacted in any volumetric ratio sufficient to partially dissolve one or more ingredients of the first mixture and form a second mixture in the second step. For example, the first mixture containing the hydrocarbon solvent and the metalated ligand complex and the polar solvent may be contacted in a volumetric ratio of about 2:1 or less, about 1.9:1 or less, or about 1.7:1 or less. The polar solvent and the first mixture may be contacted in a volumetric ratio of about 1.1:1 or more, about 1.3:1 or more, or about 1.5:1 or more. The polar solvent, the hydrocarbon solvent, or both may be chosen for the formation of the metalated ligand complex based on time considerations, solubility of any of the components of the mixture, reaction temperature, boiling points of the solvents, or for a combination of reasons. The second mixture of polar and hydrocarbon solvent, metalation compound, ligand complex, and/or metaled ligand complex may be mixed for any period of time sufficient to partially dissolve one or more components of the mixture and/or improve formation of the metalated ligand complex.

Before and/or during the second step the second mixture may be sparged with a gas at a pressure sufficient to assist with formation of the carbonylation catalyst. The sparging may introduce a gas into the second mixture that assists with stability or formation of the metal carbonyl and/or carbonylation catalyst. The sparging may displace other gases (e.g., argon, nitrogen, etc.) within the second mixture. The gas may be carbon monoxide, syngas (i.e., hydrogen and CO), or both. The partial pressure of the sparging gas may be any partial pressure that enhances the formation of the carbonylation catalyst. The pressure of the sparging may be about 200 kPa or less, about 150 kPa or less, or about 100 kPa or less. The pressure of the sparging may be about 10 kPa or more, about 40 kPa or more or about 70 kPa or more. The single vessel may be equipped with any device sufficient to sparge the second mixture and/or reaction mixture.

In the second step, the metalated ligand complex may be contacted with a metal carbonyl so that the carbonylation catalyst is formed in the second mixture. The second step may be performed in a second vessel without isolating any compounds between moving the mixture from the first step to the second step. The second vessel may be a different vessel than the first vessel and may include any component or characteristic described within the context of the first component. The second step may be performed in the same single vessel as the first step, and the single vessel of the second step may have any characteristic, form, or equipped items as the single vessel of the first reaction. The second reaction may be performed in an environment that is moisture, air, and/or oxygen free so that formation and/or stability of the carbonylation catalyst is not negatively affected. For example, the second reaction may be performed in an inert atmosphere, such as with a Schlenk line and/or dry box with an atmosphere of an inert gas.

Before the second step, the metal carbonyl may first be contacted with a polar solvent to improve formation of the carbonylation catalyst and/or improve solubility of the metal carbonyl within the second mixture. The metal carbonyl may be contacted with the polar solvent and mixed for a period of time sufficient to form a precursor mixture containing the polar solvent. For example, the metal carbonyl and the polar solvent may be mixed for about 1 hour or less, about 30 minutes or less, or about 15 minutes or less. The metal carbonyl and the polar solvent may be mixed for about 30 seconds or more, about 5 minutes or more, or about 10 minutes or more. The metal carbonyl and the polar solvent may be mixed by any means and in any container sufficient to form a precursor mixture that is combinable with the first mixture of the first step or the second mixture containing the polar and hydrocarbon solvents and the metalated ligand complex. The metal carbonyl may be free of a hydrocarbon solvent before contacting the metal carbonyl with the second mixture containing the metalated ligand complex and the polar and hydrocarbon solvents. In some examples, the metal carbonyl may contain an amount of hydrocarbon solvent for stabilizing the metal carbonyl before addition to the reaction mixture, such as between about 1 and 5 mass percent, based on the total mass of the metal carbonyl before addition to the reaction mixture.

In the second step, the metal carbonyl may be contacted with the first mixture containing the hydrocarbon solvent and metalated ligand complex to form the second mixture before addition of the polar solvent to the first mixture. The metal carbonyl may be contacted with the already formed second mixture containing the metalated ligand complex and hydrocarbon and polar solvents. The metal carbonyl may be contacted with the first or second mixture in any molar ratio with the metalated ligand complex sufficient to form the carbonylation catalyst. For example, the metal carbonyl and the metalated ligand complex may be contacted in a molar ratio of about 1.5:1 or less, about 1.25:1 or less, or about 1:1 or less. The metal carbonyl and the metalated ligand complex may be contacted in a molar ratio of about 0.25:1 or more, about 0.5:1 or more, 0.75:1 or more, or 1:1 or more. The molar ratio of metal carbonyl and metalated ligand complex may be chose such that the molar ratio of metal in the metal carbonyl and metal in the ligand complex is about 1:1 or more, about 1.25:1 or more, or about 1.5:1 or more.

The metal carbonyl and the reaction mixture containing the metalated ligand complex may be mixed for any period of time sufficient to form the carbonylation catalyst. For example, the metal carbonyl and the reaction mixture containing the metalated ligand complex may be mixed for about 15 minutes or more, about 30 minutes or more or more, or about 1 hour or more. The metal carbonyl and the reaction mixture containing the metalated ligand complex may be mixed for about 24 hours or less, about 5 hours or less or less, or about 2 hours or less. The addition of the metal carbonyl and the mixing of the reaction mixture may yield a precipitate that contains the carbonylation catalyst. The reaction mixture may be substantially free of any carbonylation catalyst that is dissolved.

In a third step, the carbonylation catalyst may be removed from the reaction mixture by any separation means sufficient to yield a carbonylation catalyst with catalytic activity to form a lactone. Any technique known by the skilled artisan may be used as a separation means to separate solids and liquids and yield the carbonylation catalyst as a solid in a form that has catalytic activity and yield the other components as a liquid or solid separate from the carbonylation catalyst. For example, the single vessel used in the first and second steps may be subjected to a filtering means that collects the carbonylation catalyst in a form of a precipitate, and a container of any form may be positioned under the separation means to collect the components of the reaction mixture having a form that is liquid. The third step may be performed under conditions that are free of air, moisture, and/or oxygen so that the stability of the carbonylation catalyst is not affected and undesirable side reactions do not occur. The separation means may utilize any technique or device sufficient to collect a precipitate and allow a liquid to drain through the filter. For example, the separation means may include one or more of a vacuum filters, gravity filters, centrifugation means, decantation means, surface filters, depth filters, hot filtration, cold filtration, or any combination thereof. The third step may include pouring or contacting additional hydrocarbon and/or polar solvents over the precipitate containing the carbonylation catalyst to rinse the precipitate of additional undesirable impurities that are contained within the precipitate and are soluble in the hydrocarbon and/or polar solvents, which may be referred to as a rinsing step within the third step. The rinsing step may include adding or contacting of any amount of hydrocarbon and/or polar solvent sufficient to wash away any undesirable impurities contained within the precipitate and subjecting the precipitate that contains the catalyst to a separation means. The third step may additionally include a separation step to separate any remaining hydrocarbon and/or polar solvent from the precipitate. The separation step may include any technique sufficient to separate the hydrocarbon and/or polar solvent from the precipitate, such as subjecting the precipitate to one or more of the separation means described herein. For example, the separation step may include applying a vacuum to the precipitate to remove the hydrocarbon and/or polar solvent from the precipitate to yield the catalyst. The separation step may include applying heat to the precipitate to remove the hydrocarbon and/or polar solvent from the precipitate to yield the catalyst. Any amount of heat may be applied so long as the heat is not so high that the heat affects the stability of the carbonylation catalyst. For example, the heat may be applied to raise the temperature of separation step to about 110 degrees Celsius or less, about 90 degrees Celsius or less, or about 70 degrees Celsius or less. The heat may be applied to raise the temperature of separation step to may be about 40 degrees Celsius or more, about 50 degrees Celsius or more, or about 60 degrees Celsius or more. The separation step may include applying a nitrogen stream to the precipitate to remove the hydrocarbon and/or polar solvent from the precipitate.

After the third step, the carbonylation catalyst may be subject to additional purification methods so that less impurities are present in the final carbonylation catalyst used to perform carbonylation. The carbonylation catalyst may be subjected to a crystallization step to separate the carbonylation catalyst from one or more other undesirable impurities, such as the ligand complex, metalation compound, and/or metalated ligand complex. For example, the precipitate containing the carbonylation catalyst and other impurities from the third step could be contacted with one or more hydrocarbon and/or polar solvents, and the precipitate and the one or more hydrocarbon and/or polar solvents may be heated to a temperature sufficient to dissolve the precipitate into a crystallization mixture. The one or more polar and/or hydrocarbon solvents may be combined in any volumetric ratio sufficient to dissolve the precipitate containing the carbonylation catalyst at an elevated temperature. For example, the one or more hydrocarbon and polar solvents may be combined in a volumetric ratio of about 1:1 or more, about 1.3:1 or more, or about 1.5:1 or more. The one or more hydrocarbon and polar solvents may be combined in a volumetric ratio of about 2:1 or less, about 1.9:1 or less, or about 1.7:1 or less. After heating, the crystallization mixture may be cooled to a temperature sufficient to crystallize and, hence, precipitate the carbonylation catalyst from the one or more polar and/or hydrocarbon solvents. For example, an ice bath may be used to cool the crystallization mixture at an increased rate. After this crystallization step, the carbonylation catalyst may be substantially free of impurities.

The precipitate containing the carbonylation catalyst from the third step may be contacted with a minimal amount of hydrocarbon and/or polar solvent so that the precipitate is dissolved in the combination of solvents. The precipitate containing the carbonylation catalyst may have higher solubility in the polar solvent. The minimal amount of hydrocarbon and/or polar solvent may be any amount sufficient to dissolve substantially all of the precipitate. Over a period of time, the hydrocarbon and/or polar solvent may begin to evaporate as the hydrocarbon and/or polar solvents may have a volatility that is high. As the hydrocarbon and/or polar solvent evaporates, the carbonylation catalyst may precipitate from the crystallization mixture so that the carbonylation catalyst is substantially free of impurities.

The carbonylation catalyst may have any purity sufficient to catalyze a reaction between an epoxide and carbon monoxide to form a lactone. For example, the carbonylation catalyst may have a purity of about 90 percent or more, about 92 percent or more, or about 95 percent or more. The carbonylation catalyst may have a purity of about 100 percent or less, about 98 percent or less, or about 96 percent or less. A carbonylation catalyst may be formed by utilizing the first, second, and third steps to yield a carbonylation catalyst with a purity of less than 100 percent, and the carbonylation catalyst may be subjected to additional purification or separation steps, as described herein, to improve the purity of the carbonylation catalyst. Where the carbonylation catalyst has a purity that is less than 100 percent, the carbonylation catalyst may include one or more other impurities including byproducts, leftover reactants or starting materials, solvents, or the like. The carbonylation catalyst may include impurities in any amount such that the carbonylation catalyst still has desirable catalyst properties when forming a lactone. For example, the carbonylation catalyst may include impurities in an amount of about 10 percent or less, about 8 percent or less, or about 5 percent or less. The carbonylation catalyst may include impurities in an amount of about 9.9 percent or less, about 8 percent or less, or about 7 percent or less. The carbonylation catalyst may be substantially free of impurities.

The separation steps taught herein function to remove from the composition any unwanted components that may interfere with the formation or function of a carbonylation catalyst or any precursor of the carbonylation catalyst. For example, one or more of solvents, inorganic compounds, organic compounds, or any combination thereof may be removed from the composition so that the carbonylation catalyst is separated and in a purer form. The separation steps may include one or more of vacuum filtration, gravity filtration, centrifugation, decantation, precipitation, phase layer extraction, another technique described herein, or any combination thereof. The separation steps may utilize any method sufficient to separate one or more of solvents, inorganic compounds, organic compounds, or any combination thereof and form the carbonylation catalyst. The separation steps may remove a single type of compound at a time, such as a precipitate, or may remove a collection of compounds at a time, such as all components dissolved in a solvent. The separation steps may include forming multiple phases including one or more of one or more organic phases, an aqueous phase, a solid phase (i.e., a precipitate), one or more gaseous or vapor phases, or any combination thereof. The one or more separation steps described herein may be performed at any temperature, pressure, agitation rate, time, or any combination thereof sufficient to separate or remove any undesirable component from the composition including the ligand complexes, the metalated ligand complex, the metalation compound, the hydrocarbon and/or polar solvents, side-products thereof, derivatives thereof, or any combination thereof.

The carbonylation catalyst as described herein functions to catalyze a reaction of an epoxide and carbon monoxide to produce one or more propiolactones and other products. The carbonylation catalyst includes at least a metal carbonyl that is anionic and a metalated ligand complex that is cationic. The carbonylation catalyst may be stored in an oxygen and water free environment.

Several techniques have been theorized to illustrate the teaching of the present disclosure. One such technique is found below and represented by FIG. 1. Each teaching is simply an example of the disclosure and is not intended to limit the teachings to any single technique.

FIG. 1 is a synthetic scheme to form a carbonylation catalyst. A 500 mL media bottle is charged with 25.00 g of tetraphenyl porphyrin (TPPH₂) and 75 mL of hexanes. Triethylaluminum in an amount of 41.0 mL (1.0 M in hexanes) is added to the reaction mixture via syringe. The reaction mixture is allowed to mix for 20 hours. The reaction mixture is charged with 120 mL of tetrahydrofuran. The reaction mixture is sparged with carbon monoxide at a pressure of about 35 KPa to about 50 kPa for 10 minutes. To the slurry, 7.09 g of metal carbonyl (CO₂(CO)₈) containing 1-5 wt % hexanes is added in a solid form. The reaction is mixed at room temperature for 5 hours. After the reaction, the reaction mixture is filtered through a frit to collect the resulting purple precipitate which is rinsed with hexanes and dried under vacuum. The yield of the carbonylation catalyst is 37.3 g, which has a purity of about 95.1% as measured by proton NMR.

### ENUMERATED EMBODIMENTS

The following examples are provided to illustrate the invention but are not intended to limit the scope thereof. All parts and percentages are by weight unless otherwise indicated.

Emodiment 1. A method, comprising:
a. contacting a ligand complex, a metalation compound, and a metal carbonyl in a reaction mixture to form a catalyst, wherein the ligand complex comprises one or more of phosphine, imine, and/or hydroxyl groups bound to one or more cyclic structures; and
b. separating the catalyst from the reaction mixture.
   Emodiment 2. The method of embodiment 1, wherein contacting the ligand complex, a metalation compound, and the metal carbonyl in the reaction mixture is performed without isolating or separating any intermediates
   Emodiment 3. The method of embodiments 1 or 2, wherein step (a) is performed in a single vessel.
   Emodiment 4. The method of any one of embodiments 1 to 3, wherein step (a) is performed in moisture, air, and/or oxygen free environment.
   Emodiment 5. The method of any one of embodiments 1 to 4, further comprising:
a. contacting the ligand complex with one or more hydrocarbon solvents and the metalation compound to form the reaction mixture, before contacting with the metal carbonyl.
   Emodiment 6. The method of any one of embodiments 1 to 5, wherein contacting the ligand complex, the metalation compound, and the metal carbonyl in the reaction mixture to form the catalyst comprises:
a. mixing the reaction mixture for about 2 hours or more.
   Emodiment 7. The method of any one of embodiments 1 to 5, wherein contacting the ligand complex, the metalation compound, and the metal carbonyl in the reaction mixture to form the catalyst comprises:
a. mixing the reaction mixture for about 1.5 hours or more while applying heat.
   Emodiment 8. The method of any one of embodiments 1 to 5, wherein contacting the ligand complex, the metalation compound, and the metal carbonyl in the reaction mixture to form the catalyst comprises:
a. mixing the reaction mixture for about 5 hours or more without applying heat.
   Emodiment 9. The method of any one of embodiments 1 to 8, wherein contacting the ligand complex, the metalation compound, and the metal carbonyl in the reaction mixture to form the catalyst comprises:
a. contacting the ligand complex and a hydrocarbon solvent to form a first mixture;
b. contacting the first mixture and the metalation compound to form a metalated ligand complex in the first mixture; and
c. contacting the first mixture, a polar solvent, and the metal carbonyl in a second mixture to form the catalyst.
   Emodiment 10. The method of embodiment 9, wherein contacting the first mixture and the metalation compound to form the metaled ligand complex in the first mixture comprises:
a. mixing the first mixture for about 3 hours or more without applying heat or about 0.25 hours or more while applying heat, and wherein contacting the first mixture, a polar solvent, and the metal carbonyl in a second mixture to form the catalyst comprises:
b. mixing the first mixture, the polar solvent, and the metal carbonyl in the second mixture for about 1 hour or more.
   Emodiment 11. The method of any one of embodiments 1 to 10, wherein contacting the first mixture, the polar solvent, and the metal carbonyl to form the catalyst comprises:
a. contacting the first mixture and the polar solvent to form the second mixture;
b. sparging the second mixture with a gas at a pressure sufficient to assist with formation of the catalyst; and
c. contacting the second mixture and the metal carbonyl to form the catalyst.
   Emodiment 12. The method of embodiment 11, wherein sparging the second mixture with the gas at the pressure sufficient to form the catalyst comprises:
a. sparging the second mixture with gas at a pressure of about 100 kPa or below.
   Emodiment 13. The method of any one of embodiments 1 to 12, wherein separating the catalyst from the reaction mixture comprises:
a. filtering the catalyst in a form of a precipitate from the reaction mixture.
   Emodiment 14. The method of any one of the preceding embodiments, wherein separating the catalyst from the reaction mixture comprises:
a. applying a vacuum to the catalyst to remove the hydrocarbon and/or polar solvents from the catalyst so that the catalyst has a form of a solid;
b. applying heat to the catalyst to remove the hydrocarbon and/or polar solvent from the catalyst so that the catalyst has a form of a solid; and/or
c. applying a nitrogen stream to the catalyst to remove the hydrocarbon and/or polar solvent from the catalyst so that the catalyst has a form of a solid.
   Emodiment 15. The method of any one of embodiments 1 to 14, wherein the polar solvent is contacted with the reaction mixture in a volumetric ratio between about 1:1 or less and about 1:2 or less.
   Emodiment 16. The method of any one of embodiments 1 to 15, wherein the metalation compound is contacted with the ligand complex in a molar ratio of about 0.25:1 or more.
   Emodiment 17. The method of any one of the preceding embodiments, further comprising:
a. contacting the catalyst that is removed from the reaction mixture with one or more solvents to form crystallization mixture;
b. precipitating the catalyst from the crystallization mixture; and
c. separating the catalyst from the one or more solvents.
   Emodiment 18. The method of embodiment 17, wherein the one or more solvents comprise one or more polar solvents and one or more hydrocarbon solvent, and wherein contacting the catalyst that is removed from the reaction mixture with the one or more solvents to form the reaction mixture comprises:
a. contacting the catalyst that is removed from the reaction mixture with the one or more polar solvents and the one or more hydrocarbon solvents to form the crystallization mixture;
b. heating the crystallization mixture to a temperature sufficient to dissolve the catalyst in the one or more polar solvents and the one or more hydrocarbon solvents; and
c. cooling the crystallization mixture so that the catalyst crystallizes and precipitates from the one or more polar solvents and the one or more hydrocarbon solvents.
   Emodiment 19. The method of embodiment 18, wherein separating the one or more solvents and/or the one or more other compounds from the catalyst comprises:
a. separating the one or more polar solvents and/or the one or more hydrocarbon solvents so that the catalyst is substantially free of other compounds.
   Emodiment 20. The method of any one of the preceding embodiments, further comprising:
a. rinsing the catalyst with one or more hydrocarbon solvents.
   Emodiment 21. The method of any one of the preceding embodiments, wherein the catalyst comprises:
a. the metalated ligand complex ionically bound to the metal carbonyl in an amount of about 90 weight percent or more; and
b. the ligand complex that is unbound in an amount of about 10 weight percent or less, wherein weight percent is based on the total weight of the catalyst.
   Emodiment 22. The method of any one of the preceding embodiments, wherein the catalyst comprises:
a. the metalated ligand complex ionically bound to the metal carbonyl in an amount of about 95 weight percent or more; and
b. the ligand complex that is unbound in an amount of about 5 weight percent or less, wherein weight percent is based on the total weight of the catalyst.
   Emodiment 23. The method of any one of the preceding embodiments, wherein the catalyst comprises:
a. the metalated ligand complex ionically bound to the metal carbonyl in an amount of about 98 weight percent or more; and
b. the ligand complex that is unbound in an amount of about 2 weight percent or less, wherein weight percent is based on the total weight of the catalyst.
   Emodiment 24. The method of any one of the preceding embodiments, wherein the reaction mixture, crystallization mixture, first mixture, and/or second mixture have a form of a solution, a slurry, and/or a suspension.
   Emodiment 25. The method of any one of the preceding embodiments, wherein the catalyst has catalytic activity with carbon monoxide and epoxide, to form a lactone, succinic anhydride, or both.
   Emodiment 26. The method of any one of the preceding embodiments, wherein the catalyst has catalytic activity with carbon monoxide and an aziridine to form a lactam.
   Emodiment 27. The method of any one of the preceding embodiments, wherein the ligand complex includes one or more aromatic groups, and wherein the ligand complex comprises the one or more imine groups and the one or more cyclic structures.
   Emodiment 28. The method of any one of the preceding embodiments, wherein the ligand complex comprises a macrocycle.
   Emodiment 29. The method of any one of the preceding embodiments, wherein the ligand complex comprises one or more of a porphyrin ligand, a salen ligand, a salph ligand, a salcy ligand, a phophasalen ligand, a phosphasalph ligand, a phosphasalcy ligand, a disubstituted bipyridine ligand, a disubstituted phenanthroline ligand, a dibenzotetramethyltetraaza[14]annulene derivative, a phthalocyanine derivative, a diaminocyclohexane derivative, other derivatives thereof, or any combination thereof.
   Emodiment 30. The method of any one of the preceding embodiments, further comprising:
a. dissolving the metalation compound in a hydrocarbon solvent to form a precursor mixture having a molarity of about 1.0 or more, before contacting with the ligand complex, the metalation compound, and the metal carbonyl.
   Emodiment 31. The method of any one of the preceding embodiments, wherein the metalation compound comprises aluminum or chromium.
   Emodiment 32. The method of any one of the preceding embodiments, wherein the metalation compound comprises aluminum.
   Emodiment 33. The method of any one of the preceding embodiments, wherein the metalation compound comprises one or more of triethylaluminum, trimethylaluminum, triisobutylaluminum, chromium (II) chloride, diethyl aluminum chloride, or any combination thereof.
   Emodiment 34. The method of any one of the preceding embodiments, wherein the metalation compound comprises a trialkyl metal compound.
   Emodiment 35. The method of any one of the preceding embodiments, wherein the metal carbonyl comprises a hydrocarbon solvent in an amount of about 1 weight percent to about 5 weight percent, and wherein weight percent is based on the total weight of the metal carbonyl.
   Emodiment 36. The method of any one of the preceding embodiments, wherein the metal carbonyl comprises cobalt.
   Emodiment 37. The method of any one of the preceding embodiments, wherein the metal carbonyl comprises one or more of NaCo(CO)₄, HCo(CO)₄, CO₂(CO)₈, any Coₓ(CO)y compound, or a combination thereof.
   Emodiment 38. The method of any one of the preceding embodiments, wherein the gas comprises one or more of carbon monoxide, syngas, inert gas, or a combination thereof.
   Emodiment 39. The method of any one of the preceding embodiments, wherein the other gas comprises one or more of argon, nitrogen, or both.
   Emodiment 40. The method of any one of the preceding embodiments, wherein the hydrocarbon solvent comprises one or more of hexane, heptane, pentane, benzene, toluene, xylene, any other hydrocarbon, or any combination thereof.
   Emodiment 41. The method of any one of the preceding embodiments, wherein the polar solvent comprises a polar aprotic solvent.
   Emodiment 42. The method of any one of the preceding embodiments, wherein the polar solvent comprises one or more ester solvents, ketone solvents, aldehyde solvents, ether solvents, or any combination thereof.
   Emodiment 43. The method of any one of the preceding embodiments, wherein the polar solvent comprises one or more of tetrahydrofuran, ethyl acetate, methyl ethyl ketone, acetone, 2-cyclohexanone, 2-methyl tetrahydrofuran, butyl acetate, methyl acetate, cyclopentanone, ester solvents, ketone solvents, or any combination thereof.

### EXAMPLES

The following examples are provided to illustrate the disclosure, but are not intended to limit the scope thereof.

The NMR analysis is conducted on a Varian Mercury spectrometer operating at 300.1 MHz. The sample is dissolved in THF-d8 before testing.

The in-situ-FTIR analysis tracking the catalytic activity of the carbonylation catalyst is conducted on a Mettler Toledo ReactIR 45 m equipped with a silicone tipped sentinel that is directly affixed to the bottom of the reactor.

FIG. 2A is a 1H NMR spectrum of the isolated carbonylation catalyst of Examples 1-3 that is formed by the following method and is analyzed in d8-THF. A 1 L media bottle is charged with 75.00 g of tetraphenyl porphyrin (TPPH₂) and 225 mL of hexanes. Triethylaluminum in an amount of 122.0 mL (1.0 M in hexanes) is added to the reaction mixture via syringe. The reaction mixture is allowed to mix for 20 hours. The reaction mixture is charged with 360 mL of tetrahydrofuran. The reaction mixture is sparged with carbon monoxide at a pressure of about 35 KPa to about 50 kPa for 30 minutes. To the slurry, 21.28 g of metal carbonyl (CO₂(CO)₈) containing 1-5 wt % hexanes is added in a solid form. The reaction is mixed at room temperature for 5 hours. After the reaction, the reaction mixture is filtered through a frit to collect the resulting purple precipitate which is rinsed with hexanes and dried under vacuum. The yield of the carbonylation catalyst is 112.1 g, which is a purity of about 96.4% by ¹H NMR.

FIG. 2B is a 1H NMR spectrum of the isolated carbonylation catalyst of another method of forming the catalyst as a comparative example. This is analyzed in d8-THF. The method to make the comparative example of the catalyst shown in FIG. 2B involves charging a 1 L 3-neck flask with 68.4 grams of TPPH₂ and 220 ml of anhydrous toluene. A thermocouple is placed in a side neck and a 250 ml addition funnel is placed atop the middle neck of the flask. The addition funnel is charged with 85 mL of AIEt₃ (25 wt % toluene solution). The solution is added dropwise over approximately 30 minutes to the reaction mixture. The reaction is allowed to stir at room temperature for a total of 3 hours. The reaction mixture is filtered over a 600 ml medium fritted funnel atop a 2 L Erlenmeyer flask. (TPP)AIEt is collected as a solid and is rinsed with 6×30 ml hexanes. The (TPP)AIEt is transferred to a 1 L round bottom flask and dried under vacuum overnight. 60.0 g of (TPP)AIEt is dissolved in 1120 mL of THE in a 2 L flask. To the solution, 16.2 g of CO₂(CO)₈ containing 1-5 wt % hexanes is added. The reaction is stirred at room temperature for 16 h under 7 psi*g of CO. After the reaction between (TPP)AIEt and CO₂(CO)₈, the reaction mixture is filtered through a frit. The filtrate is then transferred to a 5 L flask. While stirred, 2240 mL of anhydrous hexanes is added to the filtrate. The mixture is allowed to stand for 24-72 hours. The resulting purple precipitate is filtered by a frit, rinsed with fresh hexanes and dried under vacuum. The yield of the carbonylation catalyst is 79.2 g carbonylation catalyst, which is a purity of about 93.7% based on the 1H-NMR. From 1H-NMR of FIG. 2B in THF d-8, the product is confirmed to be [(TPP)AI(THF)₂][Co(CO)₄].

FIG. 2C is a 1H NMR spectrum of the isolated carbonylation catalyst of Example 10 that is formed by the following method and is analyzed in d8-THF. A 1 L 3-neck flask is charged with 125.00 g of tetraphenylporphyrin (TPPH₂) and 240 mL of heptane. While stirring, triethylaluminum in an amount of 31.0 mL is added to the reaction mixture via syringe. The reaction mixture is heated to 70° C. and allowed to mix for 3 hours. The reaction mixture is charged with a solution of 38.1 g CO₂(CO)₈ (stabilized with 1-5% hexanes) in 325 mL of tetrahydrofuran. The reaction is mixed at room temperature for 2 hours. After the reaction, the reaction mixture is filtered through a frit to collect the resulting purple precipitate, which is rinsed with hexanes and dried under vacuum. The yield of the carbonylation catalyst is 190.7 g, which is a purity of about 96.6% based on the 1H-NMR. From 1H-NMR of FIG. 2C in THF d-8, the product is confirmed to be [(TPP)AI(THF)₂][Co(CO)₄].

FIG. 2D is a 1H NMR spectrum of the isolated carbonylation catalyst of Examples 11-12 that is formed by the following method and is analyzed in d8-THF. A 100 mL round-bottom flask was charged with 4.00 g of tetraphenylporphyrin (TPPH₂) and 8 mL of heptane. While stirring, 0.90 mL diethylaluminum chloride is added to the reaction mixture via syringe. The reaction mixture is heated to 90° C. and allowed to mix for 3 hours. The reaction mixture was cooled to 50° C. then charged with a solution of 1.26 g NaCo(CO)₄ in 10 mL of tetrahydrofuran. The reaction was mixed at 50° C. for 2 hours. After the reaction, the reaction mixture is cooled to room temperature and is filtered through a frit to collect the resulting purple precipitate. The solid is rinsed with hexanes and dried under vacuum. The yield of the carbonylation catalyst is 6.72 g, which is a purity of about 95.3% based on the 1H-NMR (0.38 g NaCl also remains in the precipitated solid). From 1H-NMR of FIG. 2D in THF d-8, the product is confirmed to be [(TPP)AI(THF)₂][Co(CO)₄].

The comparison of FIGS. 2A and 2C-2D to 2B shows that Examples 1, 10, and 11-12 have a similar purity by NMR to the carbonylation catalyst of FIG. 2B, which utilizes extra isolation steps.

FIG. 3 is a graph showing the catalytic activity of the carbonylation catalyst of Examples 1-12 to produce beta propiolactones.

Examples 1-3 and 10-12 show the carbonylation catalyst that is made from the process described in relation to FIGS. 2A and 2C-2D, respectively. Examples 4-9 are made by the other process described in relation to FIG. 2B, which utilizes additional isolation steps to yield the carbonylation catalyst. As shown by FIGS. 2A and 2C-2D, the carbonylation catalyst of Examples 1-3 and 10-12 is a similar purity profile by NMR without the additional purification steps when comparing to the carbonylation catalyst of FIG. 2B, and the activity profile of the carbonylation catalyst formed by the new process in FIGS. 2A and 2C-2D is similar to the activity profile of the carbonylation catalyst of Examples 4-9 made by the standard process described in relation to FIG. 2B. Accordingly, Examples 1-3 and 10-12 show a carbonylation catalyst that requires fewer steps to produce a carbonylation catalyst with high purity and has similar catalytic activity to form lactones as other processes.

1. A method, comprising:
a. contacting a ligand complex, a metalation compound, and a metal carbonyl in a reaction mixture to form a catalyst, wherein the ligand complex comprises one or more of phosphine, imine, and/or hydroxyl groups bound to one or more cyclic structures; and
b. separating the catalyst from the reaction mixture.

2. The method of claim 1, wherein contacting the ligand complex, a metalation compound, and the metal carbonyl in the reaction mixture is performed without isolating or separating any intermediates.

3. The method of claim 1, wherein step (a) is performed in a single vessel.

4. The method of claim 2, wherein step (a) is performed in moisture, air, and/or oxygen free environment.

5. The method of claim 1, further comprising:
a. contacting the ligand complex with one or more hydrocarbon solvents to form the reaction mixture, before contacting the ligand complex, the metalation compound, and the metal carbonyl.

6. The method of claim 1, wherein contacting the ligand complex, the metalation compound, and the metal carbonyl in the reaction mixture to form the catalyst comprises:
a. mixing the reaction mixture for about 1 hours or more.

7. The method of claim 1, wherein contacting the ligand complex, the metalation compound, and the metal carbonyl in the reaction mixture to form the catalyst comprises:
a. mixing the reaction mixture for about 1 hour or more while applying heat.

8. The method of claim 1, wherein contacting the ligand complex, the metalation compound, and the metal carbonyl in the reaction mixture to form the catalyst comprises:
a. mixing the reaction mixture for about 5 hours or more without applying heat.

9. The method of claim 1, wherein contacting the ligand complex, the metalation compound, and the metal carbonyl in the reaction mixture to form the catalyst comprises:
a. contacting the ligand complex and a hydrocarbon solvent to form a first mixture for a period of about 5 hours or more without applying heat or about 0.25 hours or more while applying heat;
b. contacting the first mixture and the metalation compound to form a metalated ligand complex in the first mixture; and
c. contacting the first mixture, a polar solvent, and the metal carbonyl in a second mixture to form the catalyst for a period of about 1 hour or more.

10. (canceled)

11. The method of a claim 9, wherein contacting the first mixture, the polar solvent, and the metal carbonyl to form the catalyst comprises:
a. contacting the first mixture and the polar solvent to form the second mixture;
b. sparging the second mixture with a gas at a pressure sufficient to assist with formation of the catalyst; and
c. contacting the second mixture and the metal carbonyl to form the catalyst.

12. The method of claim 1, wherein separating the catalyst from the reaction mixture comprises:
a. filtering the catalyst in a form of a precipitate from the reaction mixture.

13. (canceled)

14. The method of claim 1, further comprising:
a. rinsing the catalyst with one or more hydrocarbon solvents.

15. The method of claim 1, wherein the catalyst comprises:
a. the metalated ligand complex ionically bound to the metal carbonyl in an amount of about 90 weight percent or more; and
b. the ligand complex that is unbound in an amount of about 10 weight percent or less,
wherein weight percent is based on the total weight of the catalyst.

16. (canceled)

17. (canceled)

18. (canceled)

19. The method of claim 1, wherein the catalyst has catalytic activity with carbon monoxide and epoxide to form a lactone, succinic anhydride, or both, or wherein the catalyst has catalytic activity with carbon monoxide and an aziridine to form a lactam.

20. (canceled)

21. The method of claim 1, wherein the ligand complex comprises one or more of a porphyrin ligand, a salen ligand, a salph ligand, a salcy ligand, a phophasalen ligand, a phosphasalph ligand, a phosphasalcy ligand, a disubstituted bipyridine ligand, a disubstituted phenanthroline ligand, a dibenzotetramethyltetraaza[14]annulene derivative, a phthalocyanine derivative, a diaminocyclohexane derivative, other derivatives thereof, or any combination thereof.

22. The method of claim 1, wherein the metalation compound comprises aluminum or chromium.

23. The method of claim 1, wherein the metalation compound comprises one or more of triethylaluminum, trimethylaluminum, triisobutylaluminum, chromium (II) chloride, diethyl aluminum chloride, or any combination thereof.

24. (canceled)

25. The method of claim 1, wherein the metal carbonyl comprises cobalt.

26. (canceled)

27. The method of claim 9, wherein the polar solvent comprises a polar aprotic solvent.

28. (canceled)

29. A method, comprising:
a. contacting a ligand complex, a metalation compound, and a metal carbonyl in a reaction mixture to form a catalyst, wherein the ligand complex comprises one or more of phosphine, imine, and/or hydroxyl groups bound to one or more cyclic structures, comprising:
i. contacting the ligand complex and a hydrocarbon solvent to form a first mixture;
ii. contacting the first mixture and the metalation compound to form a metalated ligand complex in the first mixture; and
iii. contacting the first mixture, a polar solvent, and the metal carbonyl in a second mixture to form the catalyst; and
b. separating the catalyst from the reaction second mixture.
